(19) United States
(12) Patent Application Publication
(10) Pub. No.: US 2025/0066057 A1
(43) Pub. Date: Feb. 27, 2025

(54) METHOD AND SYSTEM FOR RECOMMENDING PACKAGING BOX USING PRODUCT VOLUME INFORMATION

(71) Applicant: COLOSSEUM CORPORATION, INC., Seoul (KR)

(72) Inventor: Jinsu PARK, Seoul (KR)

(73) Assignee: COLOSSEUM CORPORATION, INC., Seoul (KR)

(21) Appl. No.: 18/784,633

(22) Filed: Jul. 25, 2024

(30) Foreign Application Priority Data
Aug. 24, 2023 (KR) 10-2023-0110964
Aug. 24, 2023 (KR) 10-2023-0110965

(51) Int. Cl. B65B 59/00; G06N 3/08; G06Q 10/083

(52) U.S. Cl. CPC B65B 59/003; G06N 3/08; G06Q 10/083

(57) ABSTRACT

A method and system for recommending a type of box to package products using volume information of the products is proposed. The proposal relates to a method for learning which box can most efficiently load one or more products and recommending it using artificial intelligence.

The method comprises a first step of receiving first product specification data having product size information and extracting product size information from the first product specification data; a second step of inputting the extracted product size information into a machine learning model, and the machine learning model outputting a first packaging score for each box; and a third step of searching for a box with the highest priority packaging score among the first packaging scores for each box, and obtaining and outputting box specification information corresponding to the searched box.

### CROSS REFERENCE TO RELATED APPLICATION

The present application claims priority to Korean Patent Application No. 10-2023-0110964 and No. 10-2023-0110965, filed Aug. 24, 2023, the entire contents of which are incorporated herein for all purposes by this reference.

### BACKGROUND OF THE INVENTION

### Field of the Invention

The present disclosure relates to a method for recommending a type of a box to package products using volume information of the products, and a system for executing the method.

More particularly, the present disclosure relates to a method for learning which box can most efficiently load one or more products and recommending it using artificial intelligence.

### Description of the Related Art

Since the end of the 20th century, PCs have become widely available and high-speed communication networks have been established, so that various internet services using the same have developed. In particular, the number of product orders and deliveries via online is increasing every year and the number of cases of purchasing products or providing services non-face-to-face is gradually increasing due to the coronavirus infection that spread in year 2020. Accordingly, not only B2C logistics volume, but also B2B logistics volume is currently increasing every year.

In order to store or deliver a plurality of products, the products may first be packed and put into a box, or be loaded into a container box before sealing an opening and closing panel thereof. In this case, depending on a volume of the plurality of products occupying the box or container box, a size of the box or container box containing the products may vary.

The smaller the size of the box or container box accommodating the products, the less space it takes up when storing the box or container box, thereby reducing storage costs. Also, it will be more effective as many boxes can be delivered at once when working on logistics.

Depending on the box or container box and the type of products contained in the box or container box, damage may occur or quality may change during the process of storing or delivering the products, so it is necessary to prevent such losses when storing or delivering the same products in the future.

### SUMMARY OF THE INVENTION

An objective of the present disclosure is to solve the above problems and to provide a method for recommending the best box to pack products using volume information of the products, and a system for executing the method.

In order to achieve the above objective, in an exemplary embodiment of the present disclosure, there is provided a method for recommending a packaging box using product volume information, the method comprising: a first step of receiving first product specification data having product size information and extracting the product size information from the first product specification data; a second step of inputting the extracted product size 5 information into a machine learning model, and the machine learning model outputting a first packaging score for each box; and a third step of searching for a box with the highest priority packaging score among the first packaging scores for each box, and obtaining and outputting box specification information corresponding to the searched box.

In the exemplary embodiment, the product size information of the first product specification data comprises length information for each vertical, horizontal, and height direction.

In the exemplary embodiment, the machine learning model is an artificial neural network in which an input layer is not fully connected to a hidden layer.

In the exemplary embodiment, the third step comprising: searching for first index of packaging score with the highest priority in the first packaging score for each box, which is made up of an array, and searching box name information of a box corresponding to the searched first index in a box index reference table storing box name information corresponding to each index of the array of the first packaging score for each box, and obtaining and outputting the box specification information from box specification data using the searched box name information of the box as a search key.

In the exemplary embodiment, in the third step, the higher the first packaging score for each box, the higher the priority that is given.

In the exemplary embodiment, before the first step, it further comprises a pre-learning step of training the machine learning model by specifying size information for each product as an input variable and specifying a second packaging score for each box as a target.

In the exemplary embodiment, before the pre-learning step, it further comprises a packaging score calculation step of calculating the second packaging score for each box from packaging status information in which scores are assigned for each evaluation item of storage status of the box and delivery status.

In the exemplary embodiment, each element of the packaging status information in the array is multiplied by a weight, and the multiplied values are added to calculate the second packaging score for each box.

In the exemplary embodiment, in the packaging score calculation step, generating training data containing a plurality of pairs of the size information for each product indicating length by dimension of each product of the product group stored together in the box and the second packaging score for each box indicating packaging score when products of the product group are packaged together for each box.

In the exemplary embodiment, after the third step, it further comprises: a step of creating an initial solution set generates a plurality of first sample objects having randomly generated loading order information and rotation direction information from second product specification data comprising product size information and product rotation direction count information; and a step of generating an arrangement information crosses a pair of the first sample objects with each other to generate a plurality of second sample objects, and varies the second sample objects, and selects the plurality of first or second sample objects in order of priority so as to be reset as the first sample objects.

In another exemplary embodiment of the present disclosure, there is provided a system for recommending a packaging box using product volume information, the system comprising: a box recommendation module that extracts product size information from first product specification data, and inputs the extracted product size information into a machine learning model, and searches for a box with the highest priority packaging score among first packaging scores for each box output by the machine learning model, and obtains and outputs box specification information corresponding to the searched box.

In another exemplary embodiment, it further comprises a packaging score calculation module that calculates a second packaging score for each box from packaging status information in which scores are assigned for each evaluation item of storage status of box and delivery status, and generates training data containing a plurality of pairs of size information for each product indicating length by dimension of each product of the product group stored together in the box and the second packaging score for each box indicating the packaging score when products of the product group are packaged together for each box.

In another exemplary embodiment of the present disclosure, the method comprising: a first step of determining whether all products in product specification data can be loaded into a box in box specification data, and determining whether it can be loaded into a box in other box specification data when it is determined that loading is unable; and a second step of generating an arrangement information in which product is arranged in the box from loading order information and rotation direction information randomly generated from the product specification data.

In another exemplary embodiment, in the first step, when each product cannot be placed individually in the box even if it is rotated in all directions, it determines that all products cannot be loaded into the box.

In another exemplary embodiment, in the first step, when sum of volumes of all products exceeds volume of the box, it determines that all products cannot be loaded into the box.

In the exemplary embodiment, in the first step, a machine learning mode receives box size information and size information of all products, and outputs whether all products can be loaded into the box.

In another exemplary embodiment, before the first step, it trains the machine using training data specified box size information and a plurality of product size information as an input variable and specified load ability information of all products as a target.

In another exemplary embodiment, when it determines that all product cannot be loaded into the box in the first step, it assigns the product with (i)th largest volume to (((i−1) mod n)+1)th product group, and selects the first box with a larger volume than the sum of volumes of all products, and then determines whether all products in the product group can be loaded into the first box, and selects the first box as a box in which the product will be loaded when loading is able, for each product group.

In another exemplary embodiment, when it determines that all product cannot be loaded into the box in the first step, it assigns the product for which the longest edge is (j)th longest to the (((j−1) mod m)+1)th product group, and selects a second box for which the length of all edges is longer than the length of the longest edge of the product, and then determines whether all products in product group can be loaded into the first box, and selects the second box as a box in which the product will be loaded when loading is able, for each product group.

In another exemplary embodiment, when it determines that all product cannot be loaded into the box in the first step, it executes a third step to determine whether product can be loaded into a third box in descending order of volume size, and selects the third box as a box in which the product will be loaded when loading is able, and sets a fourth box, which is smaller in volume than the third box, as the third box and executes the third step again when loading is unable.

In another exemplary embodiment, in the second step, it crosses a pair of first sample objects having randomly generated loading order information and rotation direction information from the product specification to generate a plurality of second sample objects, and selects the plurality of first or second sample objects in order of priority so as to be reset as the first sample objects.

In another exemplary embodiment, in the second step, it randomly determines variation sections within range of the number of products, and sorts the loading order information included in variation sections of the second sample objects in a reverse order, and randomly changes the rotation direction information included in the variation sections of the second sample objects.

According to the present disclosure, by recommending the optimal box to accommodate products, it can reduce costs when storing products or conducting logistics operations, and prevent damage to boxes and products.

By increasing the number of products loaded into a box or an empty three-dimensional space and the density within the box or three-dimensional space, it can reduce costs when storing products or conducting logistics operations.

In addition, before generating an arrangement information of products, it can reduce calculation costs and time by determining whether multiple products can be loaded into a box and excluding boxes that cannot be loaded.

### BRIEF DESCRIPTION OF THE DRAWINGS

FIG. 1A is a block diagram briefly illustrating a system for recommending a packaging box using product volume information according to an exemplary embodiment of the present disclosure. FIG. 1B is a block diagram briefly illustrating a computing device included in the system.

FIG. 2A is a flowchart briefly illustrating a method for recommending a packaging box using product volume information according to the exemplary embodiment of the present disclosure.

FIG. 2B is a flowchart briefly illustrating a method for generating product arrangement information by using product volume information according to another exemplary embodiment of the present disclosure.

FIG. 3A is a perspective view briefly illustrating a box in the exemplary embodiment of the present disclosure. FIG. 3B is a view briefly illustrating dimension information after a product is rotated in the exemplary embodiment of the present disclosure.

FIGS. 4A to 4D are views briefly illustrating schemas of box specification data and product specification data, and packaging status data in the exemplary embodiment of the present disclosure.

FIG. 5A is a view briefly illustrating a machine learning model included in the system in another exemplary embodiment of the present disclosure. FIG. 5B is a flowchart briefly illustrating a method for determining whether a product can be divided and loaded into multiple boxes.

FIG. 6A is briefly illustrating schema of training data in the exemplary embodiment of the present disclosure. FIG. 6B is briefly illustrating the process of adding training data.

FIG. 7A is briefly illustrating variables input and output during the learning process of a machine learning model in the exemplary embodiment of the present disclosure. FIG. 7B is briefly illustrating variables input and output during the inference process of a machine learning model.

FIG. 8 is a flowchart briefly illustrating a method for recommending a packaging box using product volume information according to another exemplary embodiment of the present disclosure.

FIG. 9 is a view briefly illustrating a schema and data of sample object data in the exemplary embodiment of the present disclosure.

FIG. 10 is a flowchart briefly illustrating detailed steps of generating an arrangement information in the exemplary embodiment of the present disclosure.

FIG. 11A is a view briefly illustrating a standard for loading a product into a box according to a DBLF packing method in the exemplary embodiment of the present disclosure, and FIG. 11B is a view briefly illustrating each available space when the product is loaded into the box.

FIG. 12 is a view briefly illustrating DBLF result data and a schema thereof in the exemplary embodiment of the present disclosure.

FIGS. 13A and 13B are views briefly illustrating an information exchange process in a sample object crossing step in the exemplary embodiment of the present disclosure.

FIGS. 14A and 14B are views briefly illustrating an information change process in a sample object variation step in the exemplary embodiment of the present disclosure.

FIG. 15 is a view briefly illustrating a schema and data of loading result data output by the system in the exemplary embodiment of the present disclosure.

FIG. 16 is a view briefly illustrating data output from a display device in the exemplary embodiment of the present disclosure.

### DETAILED DESCRIPTION OF THE INVENTION

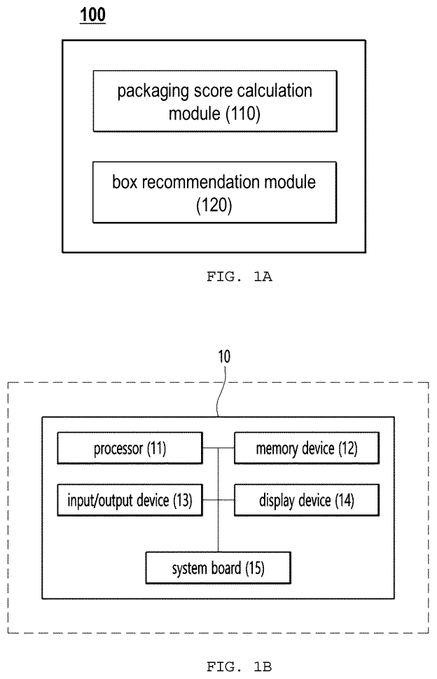

FIG. 1A is a block diagram briefly illustrating a system for recommending a packaging box using product volume information according to an exemplary embodiment of the present disclosure. FIG. 1B is a block diagram briefly illustrating a computing device included in the system.

The system 100 for recommending a packaging box using product volume information according to the exemplary embodiment f the present disclosure may include a packaging score calculation module 110 and a box recommendation module 120, respectively.

The packaging score calculation module 110 receives storage information corresponding to a box and products contained in the box and delivery information, and calculates and outputs a packaging score based on the storage information and the delivery information. Also, the packaging score calculation module 110 generates training data containing the packaging score for each box in response to one or more products.

The box recommendation module 120 receives volume information of the plurality of products and outputs the packaging score for each box that will accommodate the products. The box recommendation module 120 comprises a machine learning model, and trains the machine learning model using training data that specifies the volume information of the products as input variables and specifies the packaging score for each box as target.

The system 100 for recommending a packaging box using product volume information according to the exemplary embodiment of the present disclosure may be a single computing device or a set of a plurality of computing devices. Alternatively, in the single computing device or the plurality of computing devices, the system 100 may be a component to execute a method for recommending a packaging box using product volume information according to the exemplary embodiment of the present disclosure.

The computing device 10 included in or including the system 100 includes a processor 11, a memory device 12, an input/output device 13, a display device 14, and a system board 15.

The processor 11 performs an operation of reading and changing data input into the system 100 or generating data output to the outside. In addition, the processor 11 interprets and processes computer-readable instructions that execute the method according to the exemplary embodiment of the present disclosure. The processor 11 may be a microprocessor including: a controller for interpreting instructions and generating control signals for execution; an arithmetic and logic unit for executing arithmetic and logical operation instructions; a register for storing a plurality of instructions, a position of a next instruction to be executed, and data to be input or output; a cache memory for temporarily storing data exchanged between the processor 11 and the memory device 12; and a system bus, which is a passage through which data moves within the processor 11. For example, the processor may be any one of a central processing unit, a graphic processing unit, or a digital signal processor.

The memory device 12 stores data that is processed or input/output within the system 100. In addition, the memory device 12 stores computer-readable instructions for executing the method according to the exemplary embodiment of the present disclosure. The memory device 12 may include a main memory device and an auxiliary memory device. The main memory device may include a random access memory device or a flash memory device. For example, the main memory may include, as the random access memory device, one or more of a static RAM (SRAM), a dynamic RAM (DRAM), a magneto-resistive RAM (MRAM), a spin-transfer torque magneto-resistive RAM (STT-MRAM), a phase RAM (PRAM), a resistive RAM (RRAM), and a ferroelectric RAM (FeRAM). The auxiliary storage device may include one or more of a hard disk drive, a solid state drive (SSD), an optical disc drive, and a magnetic tape. The input/output device 13 receives input of data into the system 100 and outputs data to the outside. In addition, the input/output device 13 receives input of computer-readable instructions that execute the method according to the exemplary embodiment of the present disclosure. The input/output device may include an external input/output terminal and a driver device for processing the external input/output terminal. For example, the external input/output terminal may include a serial port, a parallel port, a small computer system interface (SCSI) port, a universal serial bus (USB) port, an IEEE 1394 port, an external serial advanced technology attachment (e-SATA) port, and a thunderbolt port. In addition, the input/output device may include a network interface controller, and the network interface controller may be connected to a local area network (LAN) based on Ethernet in a wired manner, or may be connected to a wireless local area network (WLAN) based on Wi-Fi in a wireless manner.

The display device 14 may display data processed by the processor 11 or stored in the memory device 12. The display device 14 may be a display or a printing device.

The system board 15 connects the processor 11, the memory device 12, the input/output device 13, and the display device 14 to each other, and provides a path for data processed by the system 100. The system board 15 may include an address bus, an instruction bus, a data bus, a chipset device for controlling a bus, and a power system.

The system 100 may be connected to a terminal device located outside the system 100, a personal area network (PAN), a local area network (LAN), a metropolitan area network (MAN), and a wide area network (WAN), and may receive data from an external terminal device or transmit data to the external terminal device by using a data communication protocol such as a transmission control protocol/internet protocol (TCP/IP), a server message block (SMB), a common internet file system (CIFS), and an network file system (NFS).

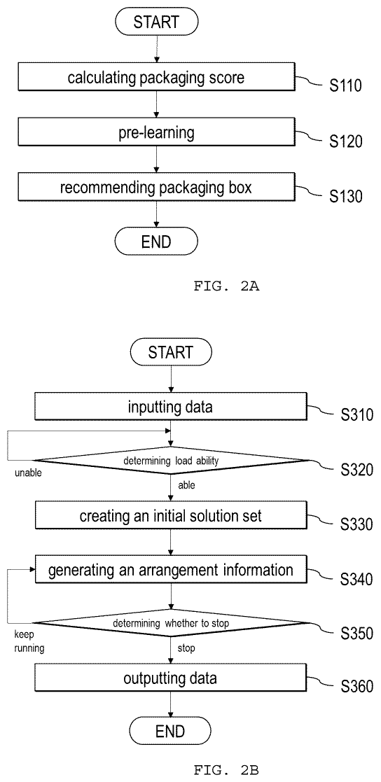

FIG. 2A is a flowchart briefly illustrating a method for recommending a packaging box using product volume information according to the exemplary embodiment of the present disclosure.

The method for recommending a packaging box using product volume information according to the exemplary embodiment of the present disclosure may include the step of calculating packaging score S110, the step of pre-learning S120, and the step of recommending packaging box S130.

In the step of calculating packaging score S110, the packaging score calculation module 110 receives storage information corresponding to a box and products contained in the box and delivery information, and calculates and outputs a packaging score based on the storage information and the delivery information.

FIG. 2B is a flowchart briefly illustrating a method for generating product arrangement information by using product volume information according to another exemplary embodiment of the present disclosure.

The method for generating product arrangement information by using product volume information to another exemplary embodiment of the present disclosure may include the step of inputting data S210, the step of determining load ability S220, the step of creating an initial solution set S230, the step of generating an arrangement information S240, the step of determining whether to stop S250, and the step of outputting data S260. Each step may be stored as computer-readable instructions in a recording medium, and the system 100 may execute each step by reading the instructions from the recording medium.

The step of creating an initial solution set S230, step of generating an arrangement information S240, step of determining whether to stop S250, and step of outputting data S260 may be the same as the corresponding step in an exemplary embodiment of the present disclosure.

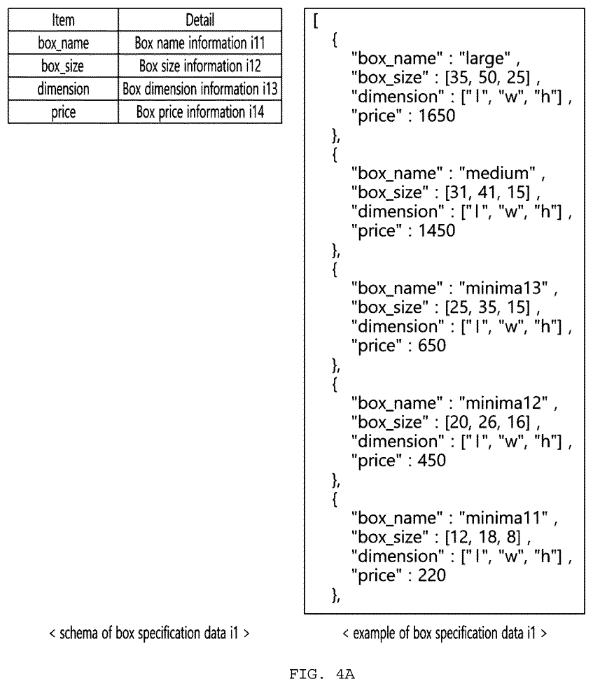

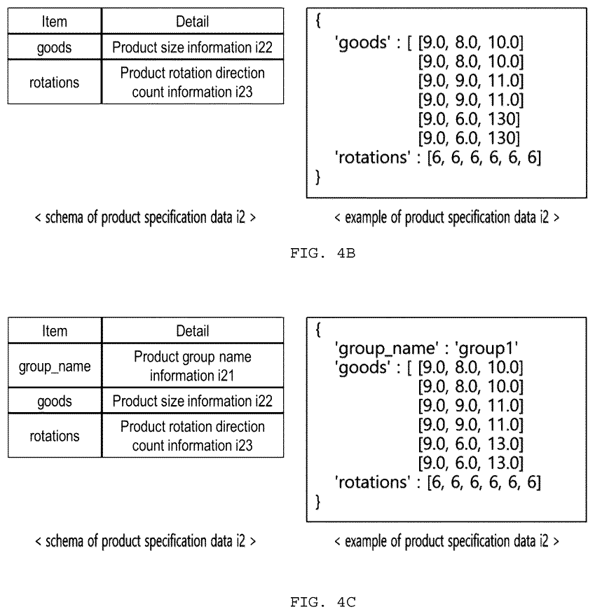

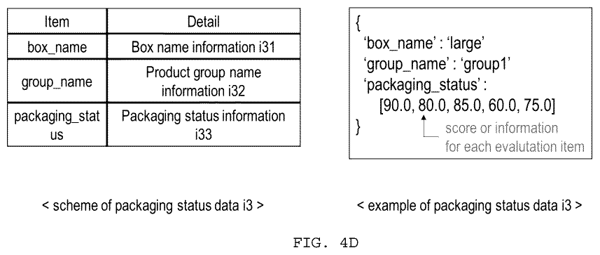

In the step of inputting data S210, the system 100 receives the box specification data i1 and the product specification data 12 as shown in FIGS. 4A to 4C.

The system 100 may further receive input of hyper-parameters serving as comparison standards in each step. As the hyper-parameters, the system 100 may further receive: box margin information in consideration of spaces occupied by cushioning items or product packing items within a box; solution set size information that is the number of sample objects and generated in the step of creating an initial solution set S230; maximum evolution generation count information regarding an iteration count in the step of generating an arrangement information S240; length information of slicing sections when sample objects are crossed; length information of variation sections when the sample objects are varied; identical object count threshold ratio information regarding a ratio of the number of child objects having the same information as each other to a plurality of child objects generated in the step of determining whether to stop S250; etc. Alternatively, the system 100 may receive input of the hyper-parameters before the step of inputting data S210, or may be in a state of storing the hyper-parameters in advance.

In the step of determining load ability S220, the system 100 determines whether all products can be loaded together into the box. The system 100 determines whether all products indicated by the product specification data i2 can be loaded into the box products indicated by the box specification data i1.

If each product cannot be placed individually in the box even if it is rotated in all directions, the system 100 can determine that all products cannot be loaded into the box. In advance, the system 100 can determine whether a product can be loaded into the box by comparing the length of the product in the vertical, horizontal, and height directions with the length of the corresponding box in the vertical, horizontal, and height directions. If one or more of the lengths of the product in the vertical, horizontal, or height directions exceed the lengths of the corresponding box in the vertical, horizontal, or height directions, the system 100 can compare the length in the vertical, horizontal, and height directions when the product is rotated with the length in the vertical, horizontal, and height directions of the corresponding box to determine whether the product can be loaded into the box. Even if the product is rotated in all rotation directions, if one or more of the lengths of the product in the vertical, horizontal, and height directions exceed the length of the corresponding box in the vertical, horizontal, and height directions, the system can determine that the product cannot be loaded into the box.

The system can calculate the sum of the volumes of all products and compare the sum of the volumes of all products with the volume of the box. When the sum of the volumes of all products exceeds the volume of the box, it can be determined that all products cannot be loaded into the box together.

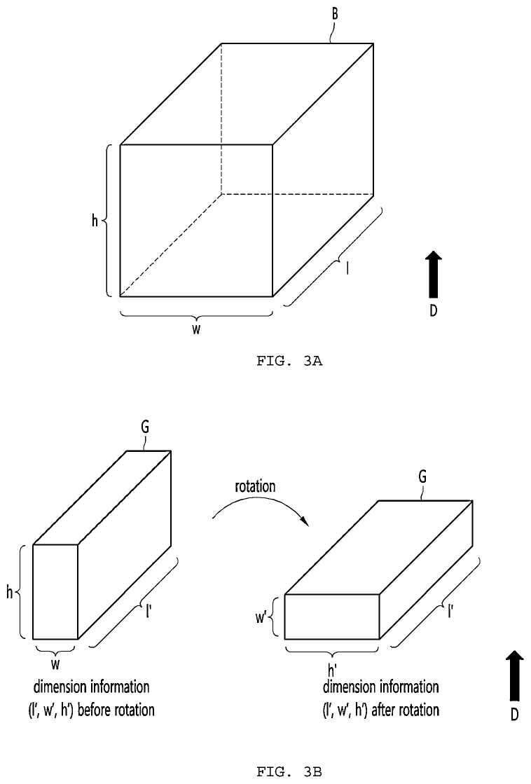

FIG. 3A is a perspective view briefly illustrating a box in the exemplary embodiment of the present disclosure. FIG. 3B is a view briefly illustrating dimension information after a product is rotated in the exemplary embodiment of the present disclosure. FIGS. 4A to 4D are views briefly illustrating schemas of box specification data and product specification data, and packaging status data in the exemplary embodiment of the present disclosure.

In the exemplary embodiment of the present disclosure, a box B is a three-dimensional item having an empty interior space and may accommodate one or more products G. The box B may have the shape of a rectangular parallelepiped or cube, but is not limited to a specific shape. For example, the box B may be a rectangular paper box, a plastic box, or a container box made of metal. The product G may be a tangible object in the shape of a rectangular parallelepiped or cube containing contents. However, the form of the product G is not limited to a specific form.

Box specification data i1, product specification data i2, and packaging status data i3 may be generated outside the system 100 and input into the system 100.

As shown in FIG. 4A, the box specification data i1 represents volume information of a box B. The box specification data i1 may include box name information i11 for identifying one box from other boxes, box size information i12 for representing a length for each dimension, and box dimension information i13 for setting a dimension for each direction such as a vertical, horizontal, or height direction, and may additionally include box price information i14. In the box size information i12, the unit of length for each dimension may be any one of cm, m, inch, foot, yard, and mile. In addition, the box size information i12 is an array of numbers, and each element can represent the length in the vertical, horizontal, and height directions.

The box specification data i1 may be stored in the format of JavaScript Object Notation (JSON), YAML Ain′t Markup Language (YAML), or extensible Markup Language (XML).

For example, in a case where a box whose name is “large” has a length of 35 cm in a vertical direction 1, a length of 50 cm in a horizontal direction w, a length of 25 cm in a height direction h, and a price of 1,650 Korean won, box name information i11 is expressed as “large”, box size information i12 is expressed as [35, 50, 25], and box dimension information i13 is expressed as [“l”, “w”, “h”], additionally box price information i14 is expressed as 1650, and such information may be stored in the JSON format.

As shown in FIGS. 4B and 4C, the product specification data i2 represents volume information for each of one or more products G. The product specification data i2 may include: product group name information i21 for distinguishing from other product specification data, product size information i22 for representing a length for each dimension of a product; and product rotation direction count information i23 for representing the number of rotatable directions for each product. For the plurality of products, the product specification data i2 may include the product size information i22 and product rotation direction count information i23. The product group name information i21 may not be included in the product specification data i2 as show in FIG. 4B.

In the product size information i22, the unit of length for each dimension may be any one of cm, m, inch, foot, yard, and mile. In addition, product size information i22 is a double array of numbers, and each element can represent an array of the length of the product in the vertical, horizontal, and height directions.

The product information may be generated by multiplying all the dimensions defined in the product size information i22. For example, the product volume information may be generated by multiplying all lengths of a product in the vertical, horizontal, and height directions.

Alternatively, the product specification data i2 may include information on a space where a product is positioned on a coordinate system. For example, assuming that a vertex of a product is positioned at the origin on a three-dimensional Cartesian coordinate system, the product specification data i2 may include coordinate information for each vertex.

The product rotation direction count information i23 may represent the number of rotations that are rotatable clockwise or counterclockwise for each of three axes in a three-dimensional Cartesian coordinate system. In general, since there are no restrictions on rotating a product clockwise and counterclockwise for each of the three axes, rotation directions may be six (i.e., 3 axes×2 directions (clockwise and counterclockwise)).

Alternatively, the product rotation direction count information i23 may represent the number of cases where edges l′, w′, and h′ in vertical, horizontal, and height directions may be changed relative to a direction D a person is facing in FIG. 3B.

For example, relative to the direction D the person is facing, when an edge in the height direction of a product is changed to an edge in the horizontal direction (h′→w′), or an edge in the horizontal direction of the product is changed to an edge in the height direction (w′→h′), dimension information may be changed from (l′, w′, h′) to (l′, h′, w′). Assuming that edges of the vertical, horizontal, and height directions respectively have lengths of (l′, w′, h′) before the product is rotated, the lengths of the edges of the vertical, horizontal, and height directions may be changed to any one of (l′, h′, w′), (w′, l′, h′), (w′, h′, l′), (h′, l′, w′), and (h′, w′, l′) depending on a rotation direction after the product is rotated.

The product rotation direction count information i23 is an array of numbers and can represent the number of rotatable directions for each product.

The product specification data i2 may be stored in the format of JSON, YAML, or XML.

For example, when the name “group1” is given to a product group containing six products rotatable in six directions and whose lengths in the vertical direction l′, the horizontal direction w′, and the height direction h′ are respectively [9, 8, 10], [9, 8, 10], [9, 9, 11], [9, 9, 11], [9, 6, 13], and [9, 6, 13], may be stored in a JSON format by representing product group name information i21 by “group1”, representing product size information i22 by [[9, 8, 10], [9, 8, 10], [9, 9, 11], [9, 9, 11], [9, 6, 13], and [9, 6, 13]] and representing product rotation direction count information i23 in order as [6, 6, 6, 6, 6, 6] for each of the six products.

As shown in FIG. 4D, the packaging status data i3 represents the status of the box and the product according to the storage and delivery process when one or more products are packaged in a specific box.

In order to identify packaging status of which box and which product, the packaging status data i3 can be stored as box name information i11 of the box specification data i1 and the product group name information i21 of the product specification data i2 as box name information i31 and product group name information i32, respectively.

The packaging status data i3 may include packaging status information i33 in which scores are given for each evaluation item of storage status and delivery status when one or more products are packaged in a specific box. The packaging status information i33 may be an array of numbers. In the array of packaging status information i33, each element is a ratio of damaged area to total area of the box, value price of the box after it is damaged, number of damaged products, value price of the product after it is damaged, type of product, storage period, delivery period, delivery satisfaction score, and evaluation score given by a logistics manager, representing information for each evaluation item of storage status and delivery status.

The packaging score calculation module 110 can calculate packaging score p by multiplying each element of array of the packaging status information i33 by the weights (w1 to wn) and adding up the multiplied values, as shown in Equation 1 below. The multiplied weights (w1 to wn) may each have a value of 0 to 1, and the sum of all weights (w1 to wn) may be 1.

$$p = {\sum }_{k = 1}^{n} {w}_{k} \cdot {e}_{k} \qquad [ Equation 1 ]$$

(where, n is length of the array of the packaging status information, wₖ is weight corresponding to kth element, ex is value of the kth element, p is the packaging score)

The packaging score calculation module 110 generates training data containing the packaging score for each box in response to one or more products.

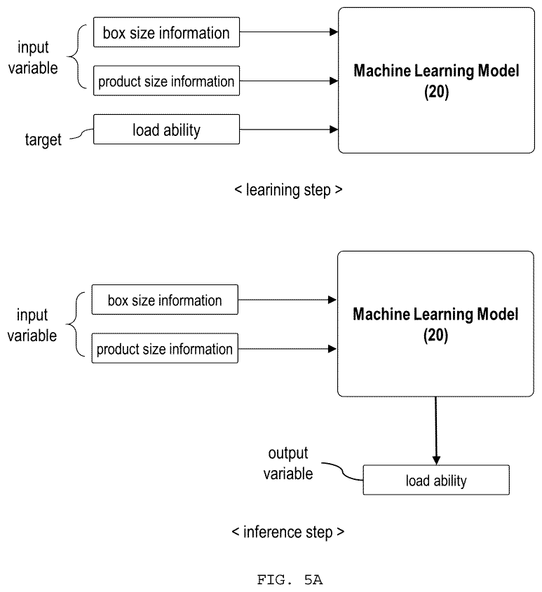

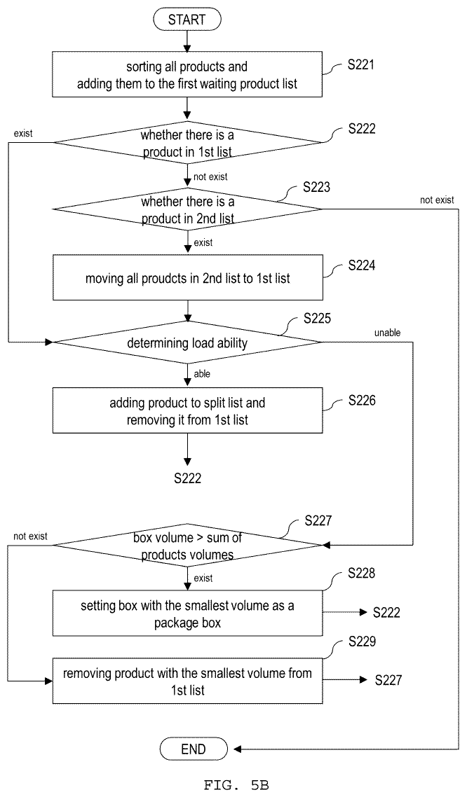

FIG. 5A is a view briefly illustrating a machine learning model included in the system in another exemplary embodiment of the present disclosure.

The system 100 may include machine learning model 20 that receives box size information and a plurality of product size information as input, and outputs information on whether all products can be loaded. Since the number of products is not constant, the machine learning model 20 may be a model that receives data of variable length and outputs classification results in response. For example, the machine learning model 20 is an artificial neural network in which the input layer is not fully connected to the hidden layer and may be convolution neural network CNN or recurrent neural network RNN.

The system 100 can train the machine using training data specifying box size information and a plurality of product size information as an input variable and specifying load ability information of all products corresponding to the input variable as a target. The machine learning model 20 can be trained in advance before the step of determining load ability S220.

If it is determined that all products have been loaded into the box in the DBLF simulated packing step of the step of generating an arrangement information S240, the system 100 can specify box size information and size information for one or more products as an input variable and label the target load ability information as “TRUE” and add it to the training data. Otherwise, if it is determined that all products cannot be loaded into the box together, the system 100 can specify box size information and size information for one or more products as an input variable and label the target load ability information as “FALSE” and add it to the training data. After adding to the training data, the machine learning model 20 can be trained again before executing the step of generating an arrangement information S240 again.

When it is determined that one product or all products cannot be loaded into the box together, the system 100 can load another box specification data i1 and then execute the step of determining load ability S220. For other boxes larger than the box in which it is determined that products cannot be loaded, the system 100 can determine whether one product or all products can be loaded into the box together.

When it is determined that all products cannot be loaded into the box with the largest volume together, the system can sort all products based on their volume sizes.

The system 100 can assign each product to belong to any one of n product groups. The system 100 can sequentially assign products to n product groups in order of product volume size. For example, the product with the largest volume can be assigned to the first product group, and the product with the second-largest volume can be assigned to the second product group. Products can be assigned by rotating through n product groups (n is a natural number of 2 or more) in order of volume size; accordingly, the product with the (n+1)th largest volume can be assigned to the first product group, and the product with the (n+2)th largest volume can be assigned to the second product group. That is, the product with the (i)th largest volume can be assigned to the (((i−1) mod n)+1)th product group; here, the mod operator is an operator that finds the remainder when dividing. In addition, the number n of product groups may be set in advanced as a hyper-parameter.

The system 100 can determine whether products belonging to each product group can be loaded into the box by the method performed in the step of determining load ability S220. The system 100 can select the box with a larger volume than the sum of the volumes of all products belonging to each product group and then determine whether all products can be loaded into the box together by the method performed in the step of determining load ability S220. The system 100 can select the box determined to be loadable for each product group and execute the step of creating an initial solution set S230.

When it is determined that all products cannot be loaded together into the box with the largest volume, the system 100 can sort all products based on length of the longest edge.

The system 100 can assign each product to belong to any one of n product groups. The system 100 can sequentially assign products to n product groups in order of length of the longest edge of product. For example, the product that the longest edge is the longest can be assigned to the first product group, and the product that the longest edge is the second longest can be assigned to the second product group. Products can be assigned by rotating through m product groups (m is a natural number of 2 or more) in order of length of the longest edge; accordingly, the product that the longest edge is the (m+1)th longest can be assigned to the first product group, and the product that the longest edge is the (m+2)th longest can be assigned to the second product group. That is, the product that the longest edge is the (j)th longest can be assigned to the (((j−1) mod m)+1)th product group. In addition, the number m of product groups may be set in advanced as a hyper-parameter.

The system 100 can determine whether products belonging to each product group can be loaded into the box by the method performed in the step of determining load ability S220. The system 100 can select the box that the length of all edges is longer than the length of the longest edge of products belonging to each product group and then determine whether all products can be loaded into the box together by the method performed in the step of determining load ability S220. The system 100 can select the box determined to be loadable for each product group and execute the step of creating an initial solution set S230.

FIG. 5B is a flowchart briefly illustrating a method for determining whether a product can be divided and loaded into multiple boxes.

The system 100 can sort products based on their volume sizes and determine whether they can be loaded into the box in order. If they can be loaded, the box is selected as the box where the products will be loaded. Otherwise, the process of determining whether they can be loaded into a box with a smaller volume than the box can be performed repeatedly. By selecting the box determined to be loadable, the step of creating an initial solution set S230 can be executed.

When it is first determined that all products cannot be loaded into the box together, the system 100 sets the box as a packaging box and sorts all products based on volume size of product, and then adds sorted products to the first waiting product list. (S221)

The system 100 determines whether there is a product in the first waiting product list. (S222)

If there is not a product in the first waiting product list, the system 100 determines whether there is a product in the second waiting product list. (S223)

If there is not a product in the second waiting product list, the system 100 finishes the method. Otherwise, the system 100 moves all products included in the second waiting product list to the first waiting product list, or replaces the first waiting product list with the second waiting product list. (S224)

If there is a product in the first waiting product list, the system 100 retrieves a product with the largest volume in the first waiting product list, and determines whether it can be loaded into the box. (S225)

If it is determined that the product can be loaded, the system 100 adds the product to the split product list and removes it from the first waiting product list. Then the system 100 executes the step of S222 again. (S226)

Otherwise, the system 100 calculates the sum of the volumes of all products in the first waiting product list and determines whether there is a box with a volume greater than the sum of the volumes. (S227)

If it is determined that there is more than one box with a volume greater than the sum of the volumes of the products, the system 100 sets the one with the smallest volume as a package box and executes the step of S222 again. (S228)

Otherwise, the system 100 removes the product with the smallest volume from the first waiting product list, and adds the removed product to the second waiting product list. Then the system 100 executes the step of S227 again. (S229)

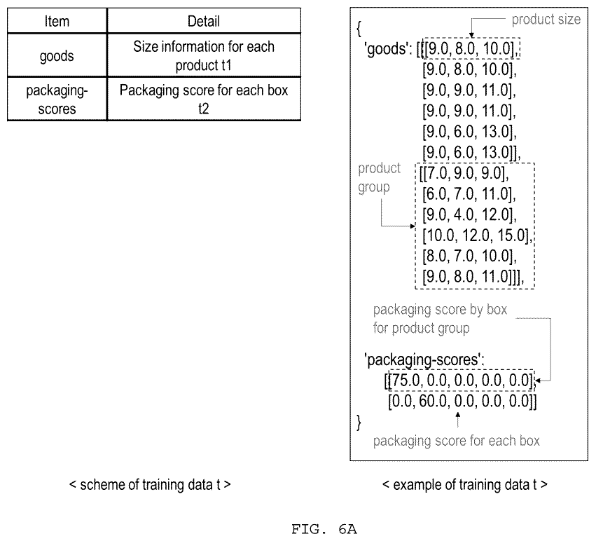

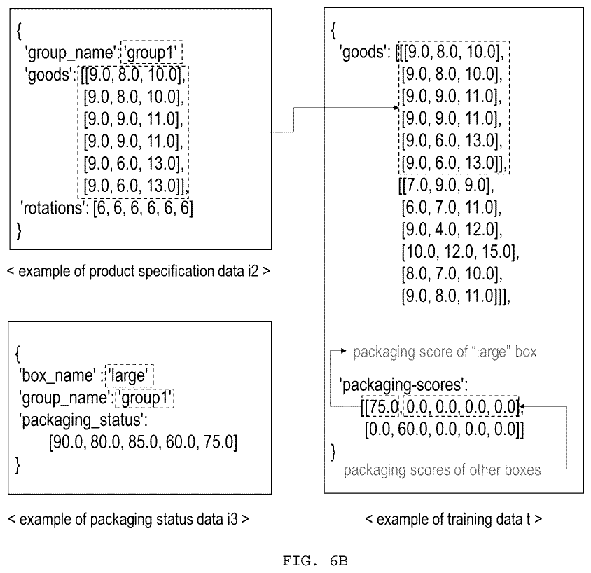

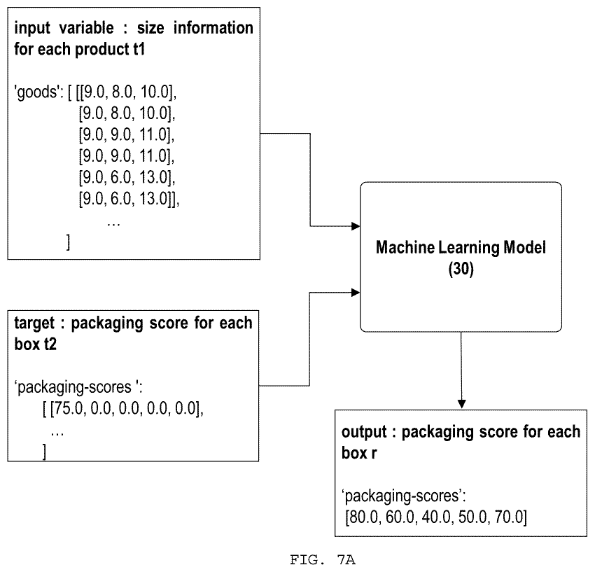

FIG. 6A is a briefly illustrating schema of training data in the exemplary embodiment of the present disclosure. FIG. 6B is a briefly illustrating process of adding training data.

Training data t can be used to gradually update parameters of the machine learning model included in the box recommendation module 120 so that the box recommendation module 120 can input the volume information of one or more products and then output the packaging score for each box.

Training data t may include multiple size information for each product t1 representing the length of each dimension for one or more products contained together in a box and packaging score for each box t2 representing the packaging score when one or more products is packaged together in each box. Size information for each product t1 is a triple array of numbers, and each element can represent an array of sizes for each product of a product group. The packaging score for each box t2 is a double array of numbers, and each element can represent an array of packaging scores for each box when packaging a product group.

When calculating the packaging score p, the packaging score calculation module 110 uses the product group name information i32 of the packaging status data i3 as a search key to extract product size information i22 from the product specification data i2, and then adds it to the size information for each product t1 of the training data t. In addition, the packaging score calculation module 110 refers to the box name information i31 of the packaging status data i3 and assigns the calculated packaging score p to the box indicated by the box name information i31, and assigns a certain value (e.g. 0 points) to the remaining boxes and then adds it to the packaging score for each box t2.

For example, as shown in FIG. 6B, the packaging score calculation module 110 uses “group1”, the product group name information (group_name) of the packaging status data i3, as a search key to extract product size information (goods) from the product specification data i2, and then adds it to the size information for each product (goods) of the training data t. In addition, the packaging score calculation module 110 assigns a calculated packaging score (75.0 points) to the box indicated by “large”, the box name information (box_name), and assigns a certain value (0.0 points) to the remaining boxes, and then adds it to the packaging score for each box (packaging-scores). The order of elements in the array of the packaging score for each box (packaging-scores) corresponds to the order of elements in the array of the size information for each product (goods). That is, the first element of the array of the packaging score for each box (packaging-scores) represents the packaging score for each box of the product group named “group1”. The first element in the array of each element of the array of the packaging score for each box (packaging-scores) may represent the packaging score when one or more products included in the product group named “group1” are loaded into a “large” box. In addition, the second to fifth elements may represent the packaging score when loading one or more products included in the product group into “medium”, “minimal1”, “minimal2”, and “minimal3” boxes, respectively.

The packaging score calculation module 110 may add training data from a plurality of packaging status data i3 or a plurality of boxes and product status information included in one packaging status data i3.

In the step of pre-learning step S120, the box recommendation module 120 receives training data and updates parameters of the machine learning model.

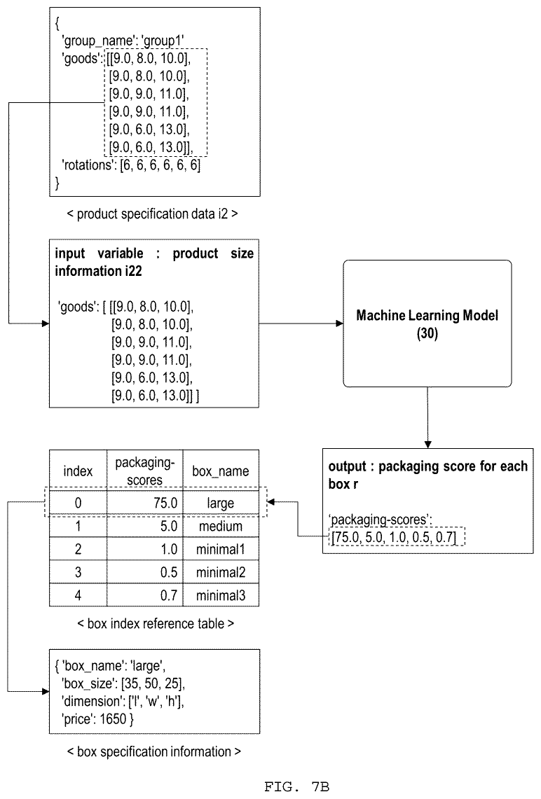

FIG. 7A briefly illustrates input and output variables during the learning process of a machine learning model in the exemplary embodiment of the present disclosure.

The box recommendation module 120 trains a machine learning model 30 by specifying size information for each product t1 as an input variable and packaging score for each box t2 as a target.

During the learning process, the element of the first dimension in the array of the size information for each product t1 and the element of the first dimension in the array of the packaging score for each box t2 correspond in index order. The machine learning model 30 receives the size information for each product t1, and then calculates the packaging score for each box r, and inputs the calculated packaging score for each box r and the packaging score for each box t2 as a target into loss function to obtain the output value, and propagates back to update the parameters of the machine learning model 30. The machine learning model 30 can repeat learning until the value of the loss function is above or below value set as a hyper-parameter.

Since the number of products included in the product specification data i2 is not constant, the number of products indicated in the size information for each product t1 of the training data t is also not constant. Therefore, the machine learning model 30 may be a model that receives size information for each product of variable length as input and outputs a packaging score for each box in response. For example, the machine learning model 30 may be an artificial neural network in which the input layer is not fully connected to the hidden layer, or may be a convolution neural network CNN or a recurrent neural network RNN.

In the step of recommending packaging box S130, the box recommendation module 120 receives the box size information of one or more products and selects the box with the highest packaging score.

FIG. 7B briefly illustrates variables input and output during the inference process of a machine learning model in the exemplary embodiment of the present disclosure.

The system 100 receives new product specification data i2 to obtain information about one or more products to be packaged. The box recommendation module 120 extracts the product size information i22 from the product specification data i2 newly entered into the system 100, and then inputs it into the machine learning model 30, and the machine learning model 30 calculates and outputs the packaging score for each box r.

The box recommendation module 120 selects the packaging score for each box with the highest priority and searches a box in the box specification data i1 using the box name information corresponding to the selected packaging score as a search key, and then outputs specification information of the box to the outside of the system 100 or displays it using the display device 14. The priority can be higher as the packaging score increases. In order to search box name information corresponding to the selected packaging score, the box recommendation module 120 may include a box index reference table that stores name information of the box corresponding to each index of the array of the packaging score for each box r.

For example, as shown in FIG. 7B, the box recommendation module 120 extracts the product size information i22 from the product specification data i2 newly entered into the system 100, and then inputs it into the machine learning model 30, and the machine learning model 30 calculates and outputs the packaging score for each box r. In addition, the box recommendation module 120 searches for the index with the highest packaging score of 75.0 in the packaging score for each box r, and then searches the type of box corresponding to the searched index 0 in the box index reference table. Afterward, the box recommendation module 120 uses the “large” box corresponding to index 0 as a search key, obtains specification information for the “large” box from the box specification data i1, and outputs it to outside of the system 100.

In FIG. 7B, the single box with the highest packaging score is selected and the specification information for that box is output. However, the present disclosure is not limited to this, and multiple boxes are selected in the order of the highest packaging score, and the specification information for each box is output. It can also be displayed.

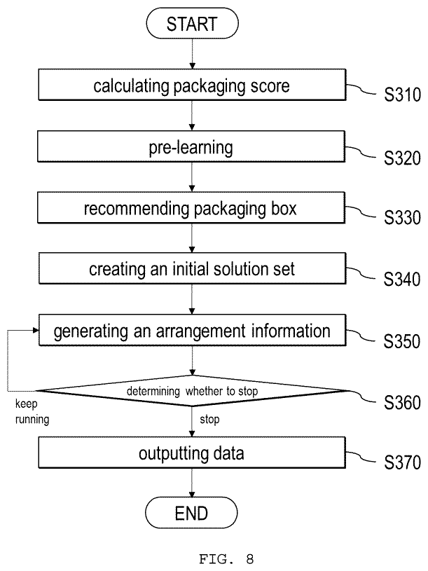

FIG. 8 is a flowchart briefly illustrating a method for recommending a packaging box using product volume information according to another exemplary embodiment of the present disclosure.

The method for recommending a packaging box using product volume information according to another exemplary embodiment of the present disclosure may include the step of calculating packaging score S310, the step of pre-learning S320, the step of recommending packaging box S330, the step of creating an initial solution set S340, the step of generating an arrangement information S350, the step of determining whether to stop S360, and the step of outputting data S370.

The step of calculating packaging score S310, the step of pre-learning S320, and the step of recommending packaging box S330 may be the same as the corresponding step in the exemplary embodiment of the present disclosure.

In the step of creating an initial solution set S340, the system 100 randomly generates sample object data including a plurality of sample objects. An object is data that includes information on an order in which products are loaded into a box and information on directions in which the products are rotated when loaded into the box. The system 100 may generate a plurality of sample objects having randomly generated loading order information and rotation direction information from the product specification data i2 newly entered.

FIG. 9 is a view briefly illustrating a schema and data of sample object data in the exemplary embodiment of the present disclosure.

Sample object data si includes each object having a pair of pieces of loading order information si1 representing product number information of products loaded in order in a box and rotation direction information si2 representing rotation direction information of the products loaded in the order. The sample object data si may include a plurality of sample objects. The sample object data si may be stored in the format of JSON, YAML, or XML. A number in each column in the rotation direction information si2 may represent a rotation direction of a product corresponding to a number positioned in the same column in the loading order information si1.

The system 100 may generate loading order information si1 of sample objects by randomly selecting numbers from 0 to (the number of products included in the product specification data−1) one by one without duplication. In addition, the system 100 may generate rotation direction information si2 of the sample objects by randomly selecting numbers from 0 to (the number of product rotation directions by product−1) for each product.

For example, when product 0, product 5, product 3, product 1, product 2, and product 4 are loaded into a box in this order, loading order information si1 may be expressed as [0, 5, 3, 1, 2, 4] as shown in FIG. 9. In addition, in a three-dimensional Cartesian coordinate system, when a clockwise rotation direction of a first axis is indicated by “0”, a counterclockwise rotation direction of the first axis is indicated by “1”, a clockwise rotation direction of a second axis is indicated by “2”, a counterclockwise rotation direction of the second axis is indicated by “3”, a clockwise rotation direction of a third axis is indicated by “4”, and a counterclockwise rotation direction of the third axis is indicated by “5”, rotation direction information si2 may be expressed as [3, 4, 4, 5, 0, 1] in a case where a rotation direction of product 0 is counterclockwise on the second axis, a rotation direction of product 5 is clockwise on the third axis, a rotation direction of product 3 is clockwise on the third axis, a rotation direction of product 1 is counterclockwise on the third axis, a rotation direction of product 2 is clockwise on the first axis, and a rotation direction of product 4 is counterclockwise on the first axis. In addition, the number of columns of the loading order information si1 and rotation direction information si2 may be equal to the number of products included in the product specification data i2.

The system 100 may generate a plurality of objects each having a pair of pieces of loading order information si1 and rotation direction information si2, and generate sample object data si that is an initial solution set. In this case, the system 100 may generate sample objects as many as a number based on solution set size information set as a hyper-parameter.

In the step of generating an arrangement information S350, the system 100 generates loading order information of product and rotation direction information for each product again by using the sample object data si, and calculates suitability of generated values. The system 100 may generate a plurality of child sample objects by crossing a pair of parent sample objects with each other, vary the child sample objects, and then select a plurality of parent and child sample objects according to priority so as to be reset as parent sample objects.

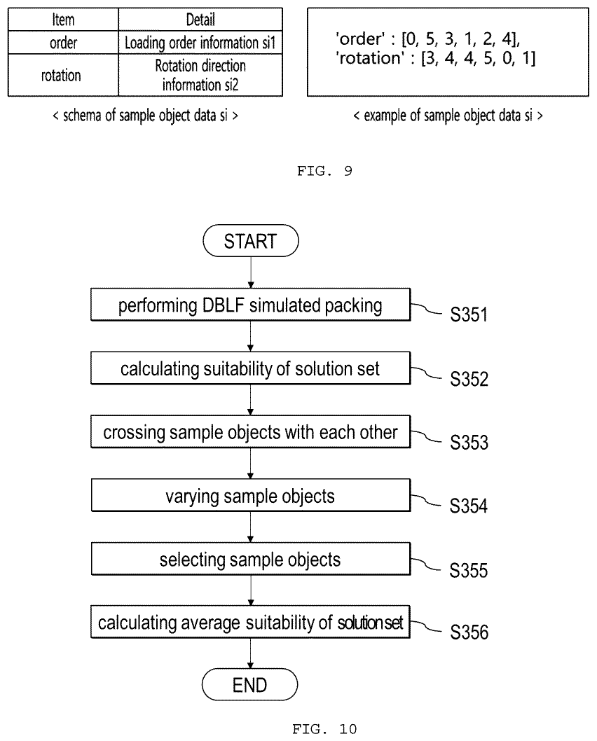

FIG. 10 is a flowchart briefly illustrating detailed steps of generating an arrangement information in the exemplary embodiment of the present disclosure.

The step of generating an arrangement information S350 may include each of a DBLF simulated packing step S351, a solution set suitability calculation step S352, a sample object crossing step S353, a sample object variation step S354, a sample object selection step S355, and a solution set average suitability calculation step S356.

In the DBLF simulated packing step S351, each time a product is loaded into a box according to the deepest bottom left fill (DBLF) method, the system 100 calculates by simulation to provide space information on a space occupied by the product and available space information on an available space capable of accommodating other products inside the box. The system 100 may generate DBLF result data including coordinates at which the product is positioned within the box when the product is loaded into the box according to the DBLF method using loading order information and rotation direction information for each sample object included in the sample object data si. The system 100 may reflect margin information of the box that is set as a hyper-parameter and generate DBLF result data when the product is loaded into the box according to the DBLF method.

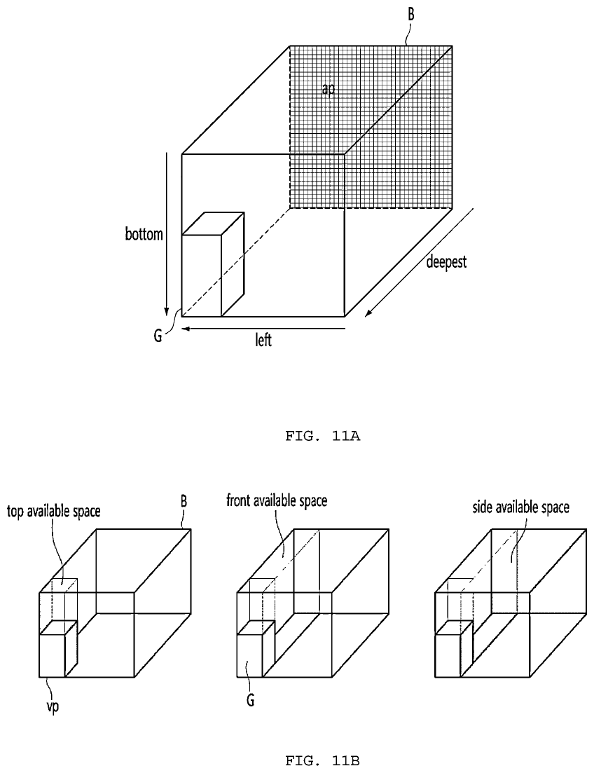

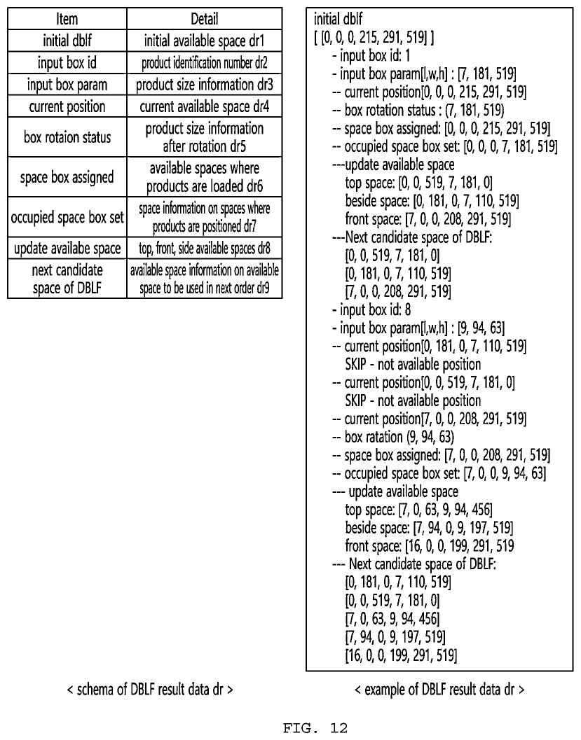

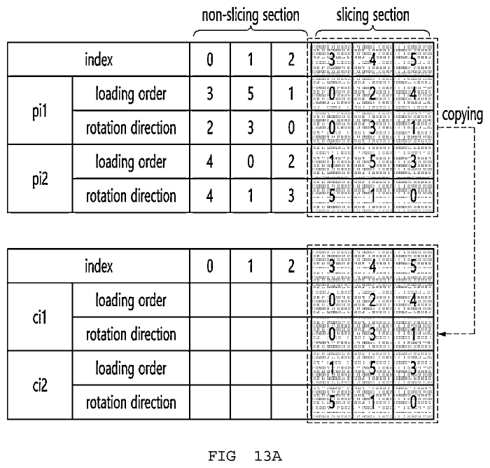

FIG. 11A is a view briefly illustrating a standard for loading a product into a box according to the DBLF packing method in the exemplary embodiment of the present disclosure, and FIG. 11B is a view briefly illustrating each available space when the product is loaded into the box.

As shown in FIG. 11A, in the deepest bottom left fill (DBLF) packing method, firstly, a product is loaded to be positioned far away from an opening ap of a box B (deepest), secondly, the product is loaded to be positioned close to the bottom of the box B (bottom), and thirdly, the product is loaded to be positioned close to the left when the opening ap is viewed from the opposite side thereof (left), thereby loading a product G by priorities.

As shown in FIG. 11B, when a product G is loaded into a box B, there may be an available space capable of accommodating other products. A top available space is an empty space adjacent to the loaded product G in a height direction, a front available space is an empty space adjacent to the loaded product G in a vertical direction, and a side available space is a space adjacent to the loaded product G in a horizontal direction.

Coordinates of a vertex vp of the box B, the vertex being a highest priority arrangement position according to the DBLF packing method, on a three-dimensional Cartesian coordinate system are [pos[0], pos[1], pos[2]], and when lengths of the loaded product G in the vertical, horizontal, and height directions are defined as l′, w′, and h′, and lengths of the box B in the vertical, horizontal, and height directions are defined as l, w, and h, each available space may be positioned at a vertex having coordinates shown in Table 1 below and may have the lengths in the vertical, horizontal, and height directions.

TABLE 1

| | Coordinate | | | Length | | |
|---|---|---|---|---|---|---|
| Available | Vertical | Horizontal | Height | Verti- | Hori- | |
| space | direction | direction | direction | cal | zontal | Height |
| Top | pos[0] | pos[1] | pos[2] + | l′ | w′ | h-h′ |
| | | | h′ | | | |
| Front | pos[0] + | pos[1] | pos[2] | l-l′ | w | h |
| | l′ | | | | | |
| Side | pos[0] | pos[1] + | pos[2] | l | w-w′ | h |
| | | w′ | | | | |

FIG. 12 is a view briefly illustrating DBLF result data and a schema thereof in the exemplary embodiment of the present disclosure.

The system 100 may generate the DBLF result data dr each time when a product loading position is determined in the DBLF simulated packing step S351. Alternatively, the system 100 may add a DBLF result calculated for each loaded product to one piece of DBLF result data dr.

In the DBLF result data dr, initial dblf dr1 indicates an initial available space in a box. For example, in a three-dimensional Cartesian coordinate system, the first three numbers [0, 0, 0] respectively represent coordinates in vertical, horizontal, and height directions where the initial available space is positioned, and the last three numbers [215, 291, 519] respectively represent lengths in the vertical, horizontal, and height directions of the initial available space.

Input box id dr2 indicates identification number information of a product being loaded, and input box parameter dr3 indicates length, width, and height lengths, which are product size information of the product being loaded.

Current position dr4 indicates coordinates and a size of an available space to load a current product. The first three numbers indicate coordinates in vertical, horizontal, and height directions of the available space, and the last three numbers indicate lengths in the vertical, horizontal, and height directions of the available space.

Box rotation status dr5 indicates length information for each dimension after a product being loaded is rotated. For example, when the product whose lengths in vertical, horizontal, and height directions are respectively [7, 181, 519] is rotated 90 degrees relative to the height direction, lengths in the vertical, horizontal, and height directions may be represented by changing the previous lengths to [181, 7, 519].

Space box assigned dr6 indicates coordinates and a size of an available space where a product is to be loaded. The first three numbers indicate coordinates in vertical, horizontal, and height directions of the available space, and the last three numbers indicate lengths in the vertical, horizontal, and height directions of the available space.

Occupied space box set dr7 indicates coordinates at which a product being loaded is positioned within a box. The first three numbers indicate coordinates of a first vertex of the product being loaded, and the last three numbers indicate coordinates of a second vertex positioned diagonally from the first vertex.

Update available space dr8 indicates coordinates and size information of top, front, and side available spaces.

Next candidate space of DBLF dr9 indicates a list of available spaces where a product may be loaded next, and may be the same as the coordinates and size information of the top, front, and side available spaces. That is, the product to be loaded next may be positioned in one of the top, front, and side available spaces.

In the solution set suitability calculation step S352, the system 100 calculates suitability of sample objects according to the arrangement of products loaded in a box. The system 100 may calculate the suitability of the sample object from one or more objective functions that are calculated according to the volume and number of products, a bottom surface area of each product, and loading types of the products.

The system 100 may execute one or more objective functions. For example, a first objective function may calculate a ratio of volumes of all products loaded in a box to a volume of the box (i.e., the ratio of the volume of all of the products/the volume of the box). In addition, a second objective function may calculate a value obtained by dividing the number of the products loaded in the box by the total number of products included in product and product specification data (i.e., the ratio of the number of the loaded products/the total number of the products). In addition, a third objective function may calculate a ratio of a sum of the bottom areas of the products in contact with the bottom of the box to an occupied bottom area of the box (i.e., the ratio of the sum of the bottom areas of the products positioned at the bottom of the box/the bottom area of the box). In addition, a fourth objective function may calculate a value obtained by dividing the volume of all of the products loaded in the box by a volume of products having maximum edge lengths (i.e., the ratio of the volume of all of the products/the volume of the products having the maximum edge lengths). In addition, the system 100 may calculate one suitability by adding up all values obtained by multiplying corresponding weights to output values of the first to fourth objective functions.

In the sample object crossing step S353, the system 100 selects a pair of sample objects from sample object data si, causes the pair of sample objects to exchange product number information included in loading order information si1 with each other, and then causes the pair of sample objects to exchange product rotation direction information included in rotation direction information si2 with each other. The system 100 may perform such an operation on a plurality of pairs of sample objects in the sample object data si.

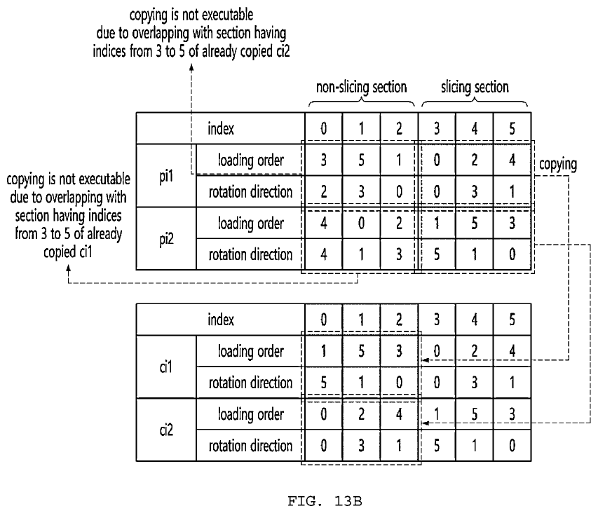

FIGS. 13A and 13B are views briefly illustrating an information exchange process in the sample object crossing step in the exemplary embodiment of the present disclosure.

The system 100 randomly determines slicing sections within a range of the number of products and copies information included in slicing sections of parent sample objects to slicing sections of child sample objects corresponding to the parent sample objects. In addition, the system 100 may sequentially search for information not overlapped with information included in the slicing sections of the child sample objects, starting from non-slicing sections of the parent sample objects, and copy the non-overlapped information to the non-slicing sections of the child sample objects that do not correspond to the parent sample objects. The system 100 may determine lengths of the slicing sections according to the slicing section length information that is set as a hyper-parameter.

The system 100 randomly selects two sample objects among a plurality of sample objects from the sample object data si to make the two sample objects a pair thereof, and then defines the two sample objects in pair as a first parent object pi1 and a second parent object pi2.

The system 100 randomly determines two slicing indices within a range of the number of products to be loaded in a box. For example, when six products are loaded into the box, each product may have a number from 0 to 5, and the system 100 may randomly select 3 and 5 among the numbers and determine the selected numbers as slicing indices. In addition, in loading order information and rotation direction information of the first parent object pi1 and the second parent object pi2, each section having indices 3 to 5 is defined as a slicing section, and each section having indices 0 to 2 is defined as a non-slicing section.

The system 100 copies in order the slicing sections of the parent objects pi1 and pi2 to those of the child objects ci1 and ci2, and crosses values not overlapped with the values in each copied slicing section with each other so as to copy the crossed values to the child objects ci2 and ci1. That is, the system 100 respectively copies the values in the slicing sections of the first and second parent objects pi1 and pi2 to those of the first and second child objects ci1 and ci2. Then, starting from the non-slicing sections of the first and second parent objects pi1 and pi2, the system 100 copies the non-overlapped values to the second and first child objects ci2 and ci1 in order.

For example, as shown in FIG. 13A, the system 100 copies the slicing section of the first parent object pi1 to the section having indices 3 to 5 of the first child object ci1 and copies the slicing section of the second parent object pi2 to the section having indices 3 to 5 of the second child object ci2.

In addition, as shown in FIG. 13B, starting from a start index 0 of the non-slicing section of the first parent object pi1, the system 100 sequentially copies, to the not-yet-copied section having indices 0 to 2 in the second child object ci2, values not overlapped with the loading order and rotation direction values positioned in the already-copied section having indices 3 to 5 in the second child object ci2. That is, since all of the loading order and rotation direction values positioned in the section having indices from a start index of the non-slicing section 0 to 2 in the first parent object pi1 are overlapped with the values already copied to the section having indices 3 to 5 in the second child object ci2, the loading order and rotation direction values positioned in the section having indices from the next start index 3 to 5 in the first parent object pi1 are sequentially copied to the section having indices from 0 to 2 in the second child object ci2. Likewise, since all of the loading order and rotation direction values positioned in the section having indices from a start index of the non-slicing section 0 to 2 in the second parent object pi2 are overlapped with the values already copied to the section having indices 3 to 5 in the first child object ci1, the loading order and rotation direction values positioned in the section having indices from the next start index 3 to 5 in the second parent object pi2 are sequentially copied to the section having indices from 0 to 2 in the first child object ci1.

In the sample object variation step S354, the system 100 changes the product number information included in the loading order information and the product rotation direction information included in the rotation direction information in the child objects ci1 and ci2.

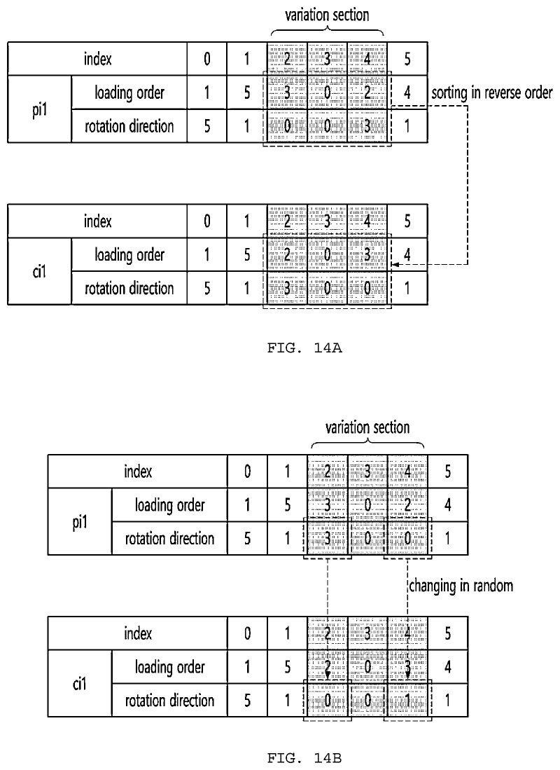

FIGS. 14A and 14B are views briefly illustrating an information change process in the sample object variation step in the exemplary embodiment of the present disclosure.

The system 100 randomly determines two variation indices in the loading order information of the child objects ci1 and ci2, the variation indices being generated in the sample object crossing step S353. For example, when six products are loaded into a box, the products may have a number from 0 to 5, and the system 100 may randomly select 2 and 4 so as to be determined as variation indices. In addition, in the loading order information, a section having indices 2 to 4 is defined as a variation section, and a section having indices 0, 1, and 5 is defined as a non-variation section. The system 100 may determine a length of the variation section according to variation section length information set as a hyper-parameter.

The system 100 may sort product numbers in a reverse direction in the variation section of the loading order information. For example, as shown in FIG. 14A, when the product numbers are “1, 5, 3” in a variation section of the loading order information of the first child object ci1, the system 100 may sort the product numbers in an order of “3, 5, 1”.

The system 100 may randomly change rotation direction information of each product in rotation direction information of the child objects ci1 and ci2. For example, as shown in FIG. 14B, in the rotation direction information of the first child object ci1, the system 100 changes rotation direction information of a product positioned at index 2 from 3 to 0, and changes rotation direction information of a product positioned at index 4 from 0 to 1.

The system 100 calculates a ranking according to one or more objective function values corresponding to the parent objects pi1 and pi2 and the child objects ci1 and ci2 in the sample object selection step S355, and then selects objects to be parent objects in the next step of generating an arrangement information S350. One or more objective function values corresponding to parent objects pi1 and pi2 and child objects ci1 and ci2 may be values output by inputting product arrangement information generated when DBLF packing is performed according to the loading order information and rotation direction information of the parent objects pi1 and pi2 or child objects ci1 and ci2 to one or more objective functions.

When products are loaded in a box according to the loading order information and rotation direction information of the child objects ci1 and c2i changed in the sample object variation step S354, the system 100 calculates output values by inputting product arrangement information to one or more objective functions. The objective functions may be the first to fourth objective functions used in the solution set suitability calculation step S352.

The system 100 uses the one or more objective function values corresponding to the parent objects pi1 and pi2 and child objects ci1 and ci2 so as to obtain the number np of other sample objects that are Pareto superior to a certain sample object and a set Sp of other sample objects for which the sample object is Pareto superior, and calculate Pareto front levels.

For example, as shown in Table 2 below, when products are loaded in a box according to the loading order information and rotation direction information of the parent objects pi1 and pi2 and child objects ci1 and ci2, first to fourth objective function values calculated by the system 100 are provided according to arrangement of the products. In this case, in a case when all values of the first to fourth objective functions of one sample object are greater than values of the first to fourth objective functions of other sample objects, the sample object is defined as in Pareto superiority.

TABLE 2

| | First | Second | Third | Fourth | | | |
|---|---|---|---|---|---|---|---|
| | objective | objective | objective | objective | | | Pareto |
| Sample | function | function | function | function | | | front |
| object | value | value | value | value | nₚ | Sₚ | level |
| First | 0.62 | 0.86 | 0.41 | 2.32 | 2 | — | 3 |
| parent | | | | | | | |
| (pi1) | | | | | | | |
| Second | 0.75 | 0.86 | 0.39 | 2.28 | 2 | — | 3 |
| parent | | | | | | | |
| (pi2) | | | | | | | |
| First | 0.87 | 0.89 | 0.57 | 3.13 | 0 | p1, p2, | 1 |
| child | | | | | | c2 | |
| (ci1) | | | | | | | |
| Second | 0.83 | 0.88 | 0.54 | 3.03 | 1 | p1, p2 | 2 |
| child | | | | | | | |
| (ci2) | | | | | | | |

The third and fourth objective function values calculated from the first parent object pi1 are greater than the third and fourth objective function values calculated from the second parent object pi2, but the first and second objective function values calculated from the second parent object pi2 are greater than the first and second objective function values calculated from the first parent object pi1, so there is no Pareto superiority/inferiority relationship between the first and second parent objects pi1 and pi2.

All of the first to fourth objective function values calculated from the first child object ci1 are greater than the first to fourth objective function values calculated from the first and second parent objects pi1 and pi2 and the second child object ci2, so the first child object ci1 is Pareto superior to the first and second parent objects pi1 and pi2 and the second child object ci2.

All of the first to fourth objective function values calculated from the second child object ci2 are greater than the first to fourth objective function values calculated from the first and second parent objects pi1 and pi2, so the second child object ci2 is Pareto superiority to the first and second parent objects pi1 and pi2.

The system 100 determines Pareto front levels according to Pareto superiority relationships between sample objects. The system 100 may assign Pareto front levels in ascending order, i.e., in order of decreasing the number np of other sample objects in Pareto superiority to a certain sample object. For example, a first child object ci1 having the smallest np value is given a Pareto front level of 1, a second child object ci2 with the next smallest np value is given a Pareto front level of 2, and first and second parent objects pi1 and pi2 with the same np value is given a Pareto front level of 3. In addition, the system 100 sorts the plurality of sample objects according to the Pareto front levels.

In a case where there is a plurality of sample objects having the same Pareto front level, the system 100 may calculate a crowding distance value by using a crowding distance algorithm of a non-dominated sorting genetic algorithm (NSGA-2) as shown in Equation 2 below.

$$cd ( i ) = {\sum }_{i = 1}^{N} \frac{{f}_{j}^{i + 1} - {f}_{j}^{i - 1}}{{f}_{j}^{max} - {f}_{j}^{min}} \qquad [ Equation 2 ]$$

(where, i is a sample object index, N is the number of sample objects, fⱼⁱ is a value of a j-th objective function of an i-th sample object, fⱼ^{max} is a maximum value of the j-th objective function, and fⱼ^{min} is a minimum value of the j-th objective function)

The system 100 selects a plurality of sample objects in order of increasing Pareto front levels (in the example, the smaller the Pareto front level, the higher the order is). In a case where Pareto front levels are the same with each other, a plurality of sample objects is selected in order of increasing crowding distance values. The plurality of sample objects selected may be newly set as sample object data si and be used as parent objects in the next sample object crossing step S353, thereby producing a plurality of child objects again.

In the solution set average suitability calculation step S356, the system 100 calculates an average value of objective function calculated from the sample objects selected in the sample object selection step S355.

When products are loaded in a box according to the loading order information and rotation direction information of sample objects selected in the sample object selection step S355, the system 100 calculates an average value of output values calculated by inputting product arrangement information into one or more objective functions.

In the step of determining whether to stop S360, the system 100 determines whether to stop iterated execution of the step of generating an arrangement information S350 and to output data or not.

The system 100 may count the number of objects having the same loading order information and rotation direction information as each other among the plurality of child objects generated in the sample object variation step S354 or plurality of sample objects selected in the sample object selection step S355, and may determine to stop the iterated execution of the step of generating an arrangement information S350 in a case where an identical object ratio is greater than or equal to a value of identical object count threshold ratio information that is set as a hyper-parameter. The identical object count threshold ratio information may be determined in a range of, for example, 50% or more. Alternatively, the system 100 may determine to stop the iterated execution of the step of generating an arrangement information S350 in a case where the step of generating an arrangement information S350 is executed exceeding a value of maximum evolution generation count information that is set as a hyper-parameter.

In the step of outputting data S370, the system 100 outputs loading result data to the outside of the system 100.

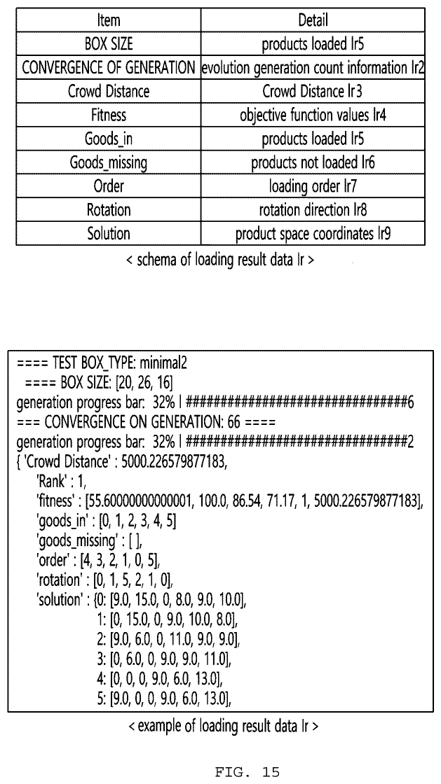

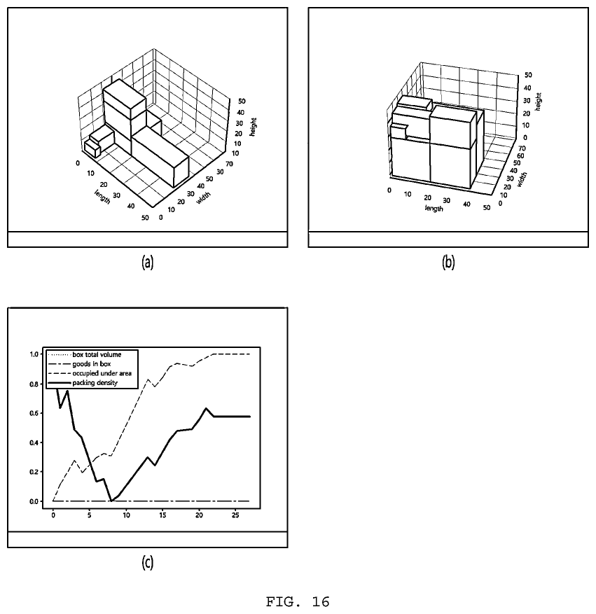

FIG. 15 is a view briefly illustrating a schema and data of loading result data output by the system in the exemplary embodiment of the present disclosure.

The system 100 may select a sample object having the highest Pareto front level and the largest crowding distance value among the plurality of sample objects selected in the sample object selection step S355, so as to generate and output loading result data lr to the outside of the system 100.

The loading result data lr includes: length information lr1 in vertical, horizontal, and height directions of a box; evolution generation count information lr2, which is an iteration count obtained in the step of generating an arrangement information; crowding distance values lr3 of selected sample objects; one or more objective function values lr4 corresponding to the selected sample objects; product number list information lr5 of products loaded into the box; product number list information lr6 of products not loaded in the box; loading order information lr7; rotation direction information lr8; and space coordinate information lr9 of spaces where the loaded products are positioned within the box. In the space coordinate information lr9 of a product, the first three numbers thereof may indicate coordinates of a first vertex of the product being loaded and the last three numbers thereof may indicate coordinates of a second vertex positioned diagonally from the first vertex.

The system 100 may output loading result data lr to the outside and then iteratively execute steps S310 to S370 for boxes having different specifications. For example, the system 100 may execute steps S310 to S370 to generate arrangement information of a plurality of products for a “large” box shown in FIG. 4A, and then iteratively execute steps S310 to S370 again to obtain arrangement information for a plurality of products for a “medium” box. The system 100 generates arrangement information of a plurality of products loaded in each box in order of box size from large to small.

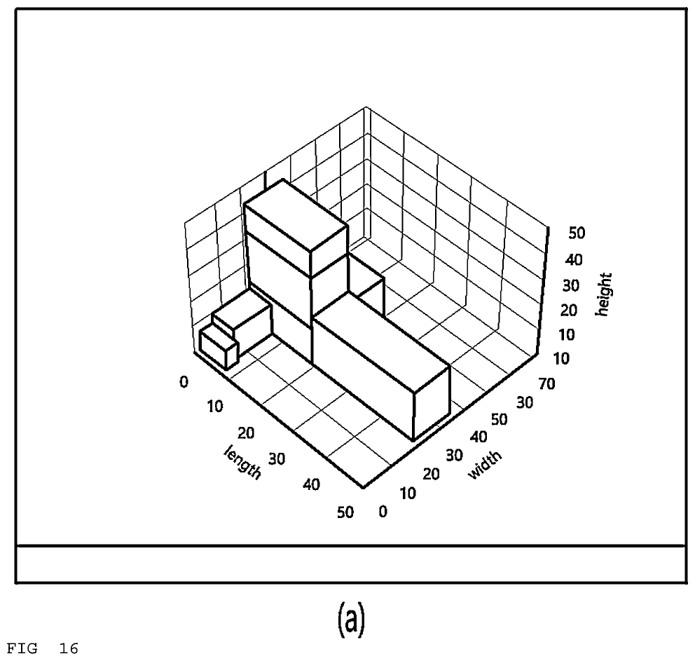

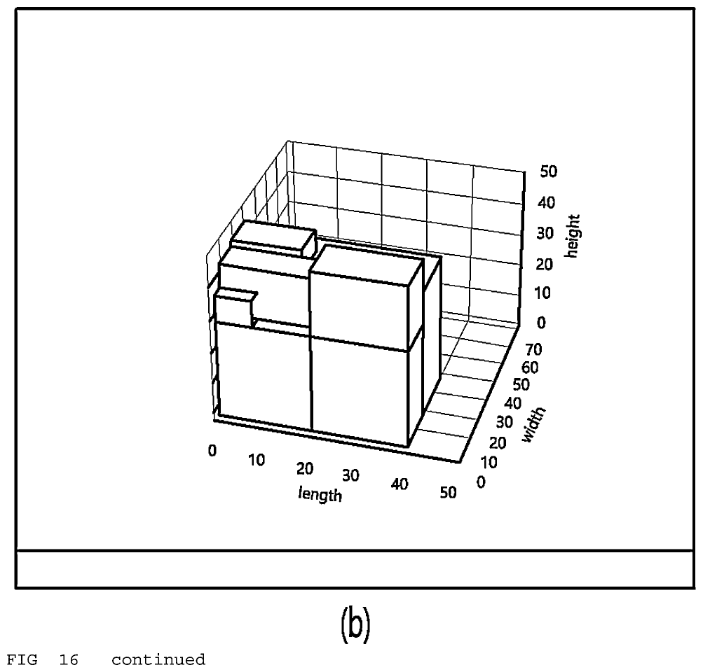

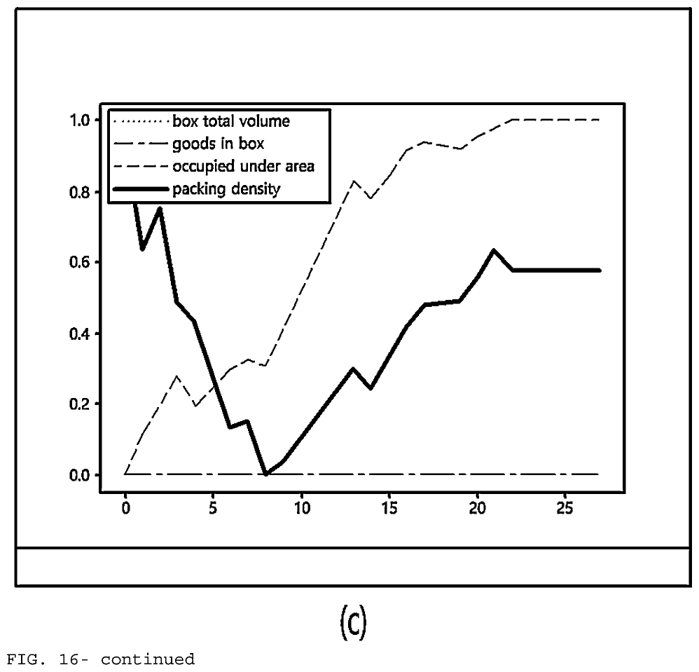

FIG. 16 shows views briefly illustrating data output on a display device in the exemplary embodiment of the present disclosure.

The system 100 may display DBLF result data dr and load result data lr, which are generated while performing each step of the method according to the exemplary embodiment of the present disclosure externally to system 100 through the display device 14.

The system 100 generates three-dimensional modeling drawings when products are loaded into a box, and displays the drawings through the display device 14 or displays the drawings on a terminal outside the system 100 through the input/output device 13.

The system 100 may generate and display a three-dimensional modeling drawing when products are loaded into a box according to the DBLF simulated packing step S131, as shown in FIG. 16 (a). In addition, the system 100 may generate and display a three-dimensional modeling drawing when product arrangement information for one box is finally generated as shown in FIG. 16 (b).

As shown in FIG. 16 (c), the system 100 may generate and display, as a graph, objective function values according to an evolution generation count that is an iteration count in the step of generating an arrangement information S350, or generate and display change of an average value of the objective functions corresponding to the plurality of sample objects.

Although the exemplary embodiments of the present disclosure have been described above, the present disclosure is not limited to the above exemplary embodiments, and as long as the exemplary embodiments do not deviate from the spirit of the present disclosure and do not impair the effect thereof, the exemplary embodiments may be implemented with various changes within the scope of the detailed description of the embodiments and the accompanying drawings. In addition, naturally, such exemplary embodiments fall within the scope of the present disclosure.

What is claimed is:

1. A method for recommending a packaging box using product volume information, the method comprising:
a first step of receiving first product specification data having product size information and extracting the product size information from the first product specification data;
a second step of inputting the extracted product size information into a machine learning model, and the machine learning model, outputting a first packaging score for each box; and
a third step of searching for a box with the highest priority packaging score among the first packaging scores for each box, and obtaining and outputting box specification information corresponding to the searched box.

2. The method for claim 1,
wherein the product size information of the first product specification data comprises length information for each vertical, horizontal, and height direction.

3. The method for claim 1,
wherein the machine learning model is an artificial neural network in which an input layer is not fully connected to a hidden layer.

4. The method for claim 1,
wherein the third step comprising:
searching for first index of packaging score with the highest priority in the first packaging score for each box, which is made up of an array, and
searching box name information of a box corresponding to the searched first index in a box index reference table storing box name information corresponding to each index of the array of the first packaging score for each box, and
obtaining and outputting the box specification information from box specification data using the searched box name information of the box as a search key.

5. The method for claim 4,
wherein in the third step, the higher the first packaging score for each box, the higher the priority that is given.

6. The method for claim 1,
wherein before the first step, it further comprises a pre-learning step of training the machine learning model by specifying size information for each product as an input variable and specifying a second packaging score for each box as a target.

7. The method for claim 6,
wherein before the pre-learning step, it further comprises a packaging score calculation step of calculating the second packaging score for each box from packaging status information in which scores are assigned for each evaluation item of storage status of box and delivery status.

8. The method for claim 7,
wherein each element of the packaging status information that is made up of an array is multiplied by a weight, and the multiplied values are added to calculate the second packaging score for each box.

9. The method for claim 7,
wherein in the packaging score calculation step, generating training data containing a plurality of pairs of the size information for each product indicating length by dimension of each product of the product group stored together in the box and the second packaging score for each box indicating packaging score when products of the product group are packaged together for each box.

10. The method for claim 1,
wherein after the third step, it further comprises:
a step of creating an initial solution set generates a plurality of first sample objects having randomly generated loading order information and rotation direction information from second product specification data comprising product size information and product rotation direction count information; and
a step of generating an arrangement information crosses a pair of the first sample objects with each other to generate a plurality of second sample objects, and varies the second sample objects, and selects the plurality of first or second sample objects in order of priority so as to be reset as the first sample objects.

11. A system for recommending packaging box using product volume information, the system comprising:
a box recommendation module that extracts product size information from first product specification data, and inputs the extracted product size information into a machine learning model, and searches for a box with the highest priority packaging score among first packaging scores for each box output by the machine learning model, and obtains and outputs box specification information corresponding to the searched box.

12. The system of claim 11,
wherein it further comprises a packaging score calculation module that calculates a second packaging score for each box from packaging status information in which scores are assigned for each evaluation item of storage status of box and delivery status, and generates training data containing a plurality of pairs of size information for each product indicating length by dimension of each product of the product group stored together in the box and the second packaging score for each box indicating the packaging score when products of the product group are packaged together for each box.
